(19) United States
(12) Patent Application Publication
(10) Pub. No.: US 2012/0047124 A1
(43) Pub. Date: Feb. 23, 2012

(54) DATABASE QUERY OPTIMIZATIONS

(75) Inventors: Songyun Duan, Hawthorne, NY (US); Anastasios Kementsietsidis, New York, NY (US); Wangchao Le, Tallahasse, FL (US); Min Wang, Cortlandt Manor, NY (US)

(73) Assignee: INTERNATIONAL BUSINESS MACHINES CORPORATION, Armonk, NY (US)

(21) Appl. No.: 12/857,624

(22) Filed: Aug. 17, 2010

(51) Int. Cl. G06F 17/30

(52) U.S. Cl. 707/714; 707/713; 707/E17.017

(57) ABSTRACT

A method of processing a query is provided. The method includes performing on a processor: receiving a database query that includes a plurality of predicates that associate a subject with an object, where one or more of the predicates is a variable predicate; generating at least one new query by selectively replacing the at least one variable predicate in the database query with a non-variable predicate; and performing the at least one new database query on a database to obtain a query result.

### STATEMENT REGARDING FEDERALLY SPONSORED RESEARCH OR DEVELOPMENT

This invention was made with U.S. Government support under Contract No. W911NF-09-2-0053 awarded by the U.S. Army. The U.S. Government has certain rights in the invention.

### BACKGROUND

The present invention relates to query systems and methods, and more specifically, to optimization systems and methods for database queries.

Resource Description Framework (RDF) is a data representation standard of the Internet. RDF is typically stored in RDF graphs and is often subjected to queries. RDF query languages can be used to write expressions that are evaluated against one or more RDF graphs in order to produce, for example, a narrowed set of statements, resources, or object values, or to perform comparisons and operations on such items. In addition, RDF queries can be used by knowledge management applications as a basis for inference actions.

Although several query languages for RDF graphs have emerged, typically, RDF graphs are queried using the Simple Protocol and RDF Query Language (SPARQL), which is modeled loosely after Structured Query Language (SQL). SPARQL can be used to express complex queries across diverse data sources (e.g., stored natively as RDF or viewed as RDF via middleware). As a relatively new query language, SPARQL does not benefit from many years of optimization research as does other query languages (e.g., SQL). Such disadvantages can hinder the adoption of SPARQL and thus RDF itself.

### SUMMARY

According to one embodiment of the present invention, a method of processing a query is provided. The method includes performing on a processor: receiving a database query that includes a plurality of predicates that associate a subject with an object, where one or more of the predicates is a variable predicate; generating at least one new query by selectively replacing the at least one variable predicate in the database query with a non-variable predicate; and performing the at least one new database query on a database to obtain a query result.

Additional features and advantages are realized through the techniques of the present invention. Other embodiments and aspects of the invention are described in detail herein and are considered a part of the claimed invention. For a better understanding of the invention with the advantages and the features, refer to the description and to the drawings.

### BRIEF DESCRIPTION OF THE SEVERAL VIEWS OF THE DRAWINGS

The subject matter which is regarded as the invention is particularly pointed out and distinctly claimed in the claims at the conclusion of the specification. The forgoing and other features and advantages of the invention are apparent from the following detailed description taken in conjunction with the accompanying drawings in which:

FIG. 1 is an illustration of a computing system that includes a optimized query system in accordance with exemplary embodiments;

FIG. 2 is an illustration of an exemplary query of the optimized query system in accordance with exemplary embodiments;

FIG. 3 is a dataflow diagram that illustrates a optimized query system in accordance with exemplary embodiments; and

FIGS. 4 and 5 are flowcharts illustrating query optimization methods of the query system in accordance with exemplary embodiments.

### DETAILED DESCRIPTION

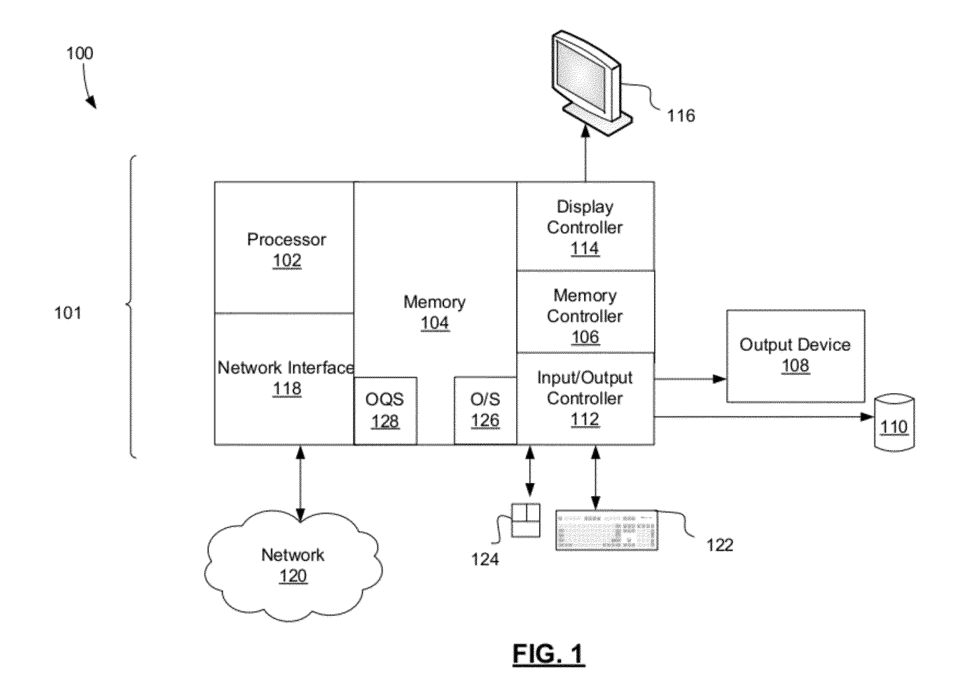

Turning now to the drawings in greater detail, it will be seen that in FIG. 1 an exemplary computing system 100 includes an optimized query system in accordance with the present disclosure. The computing system 100 is shown to include a computer 101. As can be appreciated, the computing system 100 can include any computing device, including but not limited to, a desktop computer, a laptop, a server, a portable handheld device, or any other electronic device that includes a memory and a processor. For ease of the discussion, the disclosure will be discussed in the context of the computer 101.

The computer 101 is shown to include a processor 102, memory 104 coupled to a memory controller 106, one or more input and/or output (I/O) devices 108, 110 (or peripherals) that are communicatively coupled via a local input/output controller 112, and a display controller 114 coupled to a display 116. In an exemplary embodiment, a conventional keyboard 122 and mouse 124 can be coupled to the input/output controller 112. In an exemplary embodiment, the computing system 100 can further include a network interface 118 for coupling to a network 120. The network 120 transmits and receives data between the computer 101 and external systems.

In various embodiments, the memory 104 stores instructions that can be performed by the processor 102. The instructions stored in memory 104 may include one or more separate programs, each of which comprises an ordered listing of executable instructions for implementing logical functions. In the example of FIG. 1, the instructions stored in the memory 104 include a suitable operating system (OS) 126. The operating system 126 essentially controls the performance of other computer programs and provides scheduling, input-output control, file and data management, memory management, and communication control and related services.

When the computer 101 is in operation, the processor 102 is configured to execute the instructions stored within the memory 104, to communicate data to and from the memory 104, and to generally control operations of the computer 101 pursuant to the instructions. The processor 102 can be any custom made or commercially available processor, a central processing unit (CPU), an auxiliary processor among several processors associated with the computer 101, a semiconductor based microprocessor (in the form of a microchip or chip set), a macroprocessor, or generally any device for executing instructions.

The processor 102 executes the instructions of an optimized query system (OQS) 128 of the present disclosure. In various embodiments, the optimized query system 128 of the present disclosure is stored in the memory 104 (as shown), is run from a portable storage device (e.g., CD-ROM, Diskette, FlashDrive, etc.) (not shown), and/or is run from a remote location, such as from a central server (not shown).

Generally speaking, the optimized query system 128 optimizes semantic database queries. As can be appreciated, the optimized database query may be an improved database query and may not necessarily be limited to the optimal database query. The semantic database queries can be provided in a graph query language such as, for example, SPARQL (SPARQL Protocol and RDF Query Language), RDQL (RDF Data Query Language), RQL (RDF Query Language), or other graph query language. The optimized queries can then be performed on data stored in, for example, the memory 104 or other data storage medium to return a result. The data can be stored in, for example, an RDF format. Technical effects and benefits of an optimized query include more efficient query results as well as faster query response times.

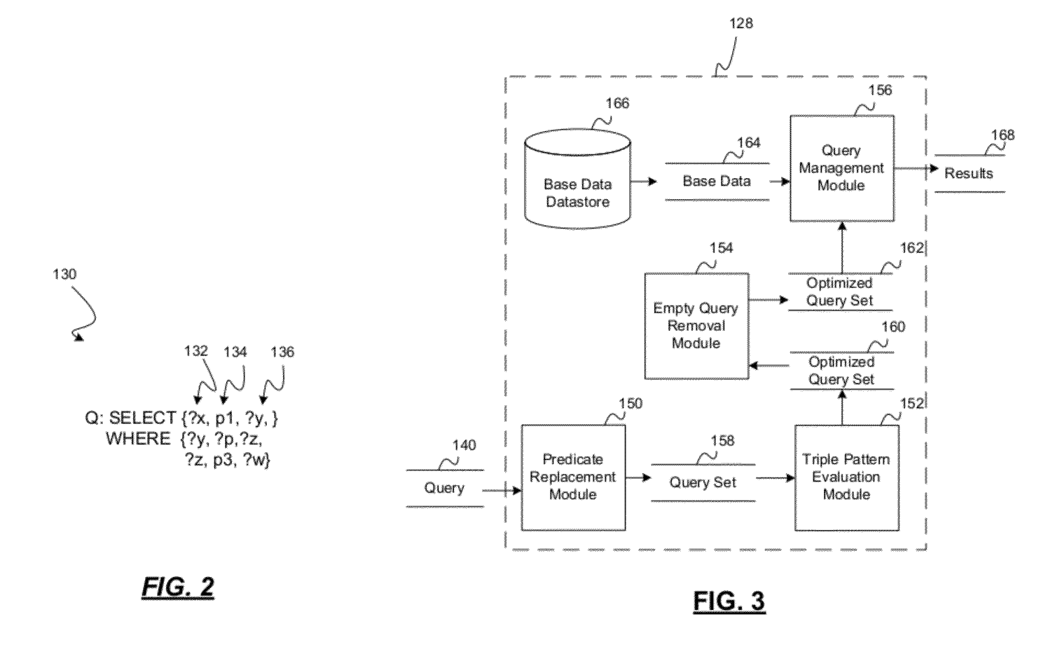

With reference now to FIG. 2, an exemplary query 130 is illustrated that is written in the graph query language SPARQL. A SPARQL query in general has the form: Q:=(SELECT|CONSTRUCT) RD (WHERE GP)?, where GP represents triple patterns (basic graph patterns), and RD represents the result description. In the example of FIG. 2, the RD includes the triple pattern (?x, p1, ?y) and the GP include the triple patterns ((?y, ?p, ?z) and (?z, p3, ?w)). Each triple pattern includes a subject 132, a predicate 134, and an object 136, where the subject 132 denotes the resource, and the predicate 134 denotes traits or aspects of the resource and expresses a relationship between the subject 132 and the object 136. At least one of the subject 132, predicate 134, or object 136 is a variable. For example, given an RDF graph G, a triple pattern on G searches for a set of subgraphs of G, each of which matches the graph pattern (by binding variables in the pattern to values in the subgraph). For SELECT queries, RD is a subset of variables in the graph pattern, similar to a projection in SQL. For CONSTRUCT queries, RD is a set of triple templates that construct a new RDF graph by replacing variables in GP with matched values. Another form of SPARQL query is: ASK GP. This query returns a boolean value indicating whether GP exists in G.

For exemplary purposes, the disclosure will be discussed in the context of the example query of FIG. 2.

Turning now to FIG. 3, the optimized query system 128 is shown in more detail in accordance with exemplary embodiments. The optimized query system 128 can include one or more sub-modules and datastores. As can be appreciated, the sub-modules can be implemented as software, hardware, firmware, a combination thereof, and/or other suitable components that provide the described functionality. As can further be appreciated, the sub-modules shown in FIG. 3 can be combined and/or further partitioned to similarly improve queries and perform the improved queries. In various embodiments, the optimized query system 128 includes a predicate replacement module 150, a triple pattern evaluation module 152, an empty query removal module 154, and a query management module 156.

The predicate replacement module 150, the triple pattern evaluation module 152, and the empty query removal module 154 receive as input a query 140 in a graph query language. In various embodiments, each module 150-156 can operate as a stand alone optimization module and can selectively perform one or more optimization techniques on the query 140. In various other embodiments, as shown in FIG. 3, a first module performs one or more optimization techniques on the query 140 and passes the optimized query to one of the other modules. The other module then performs one or more optimization techniques on the optimized query and passes the further optimized query to another module. Thus, the modules 150-156 work together to ensure that the query 140 is secure, sound, and complete. As can be appreciated, in this example, the ordering of the modules can vary without altering the spirit of the system.

In various embodiments, the predicate replacement module 150 receives as input the query 140. The query 140 can be generated, for example, by a query system as described in the U.S patent application filed contemporaneously herewith entitled, “Enforcing Query Policies Over Resource Description Framework Data,” which is incorporated herein by reference in its entirety. The predicate replacement module 150 identifies and replaces any wildcard predicates (i.e., variable predicates) in the query 140 with actual predicates. In the example query 130 of FIG. 2, the wildcard predicate is represented at ‘?p,’ and is replaced with ‘p2.’

In various embodiments, in order to perform the replacement, the predicate replacement module 150 collects or receives (flow not shown) predicate-association statistics. These statistics can be computed by counting co-occurrence frequencies of predicates in the actual data or by estimating these co-occurrence frequencies by using past query evaluations. For each wildcard predicate, the predicate replacement module 150 identifies a set of nearest joinable non-variable predicates in the query 140, and determines an intersection of joinable predicates in the set. The predicate of the query 140 is then replaced with the nearest joinable non-variable predicates. For each substitution, the predicate replacement module 150 generates a new query. The predicate replacement module 150 then generates a set of new queries (query set 158) for further optimization or for querying (flow not shown).

The triple pattern evaluation module 152 receives as input the set of new queries 158. The triple pattern evaluation module 152 identifies and removes redundant triple patterns from the set of new queries 158. For example, assume that a triple pattern is used twice in the set 158, once for predicate p1 and once for its joinable predicate p2, with variable mappings ‘Φ₁’ and ‘Φ₂,’ respectively. The triple pattern evaluation module 152 considers the variable mappings between the query and the triple patterns and constructs a new mapping ‘Φ merge’ that merges the two input mappings.

In various embodiments, the variables and constants appearing in the new query are treated as constants for the purpose of this merging (therefore only fresh variables are treated as variables for the purposes of the merging). This ensures that views are merged not just because they are copies of each other, but merged only when their predicates are joined in the same way as in the query itself. Each time view copies are merged, any variable mappings that have been applied to the views are accounted for, due to their relationship with other views corresponding to the other predicates. If Φ merge is equal to Ø, then the two copies of V can not be merged.

The triple pattern evaluation module 152 can additionally or alternatively re-order the sequence of the triple patterns in the queries of the set 158. For example, the triple pattern evaluation module can re-order the sequence based on a selectivity estimation of the triple patterns. The selectivity can be estimated by keeping statistics of past pattern evaluations, or by maintaining statistics for the actual stored data. The triple pattern evaluation module 152 then generates an optimized query set 160 for further optimization or for querying (flow not shown).

The empty query removal module 154 receives as input the optimized query set 160. The empty query removal module 154 removes any empty sub-queries from the optimized query set 160. For example, a value set for each distinct variable involved in the triple patterns is determined, and a synopsis for each value set is then constructed. Given these synopses, for the previous example, the size of the intersection of A(?y2) and A(?y3) is estimated. If the intersection size is estimated to be above some preset threshold with a reasonable probability, they can be considered as joinable. Otherwise, an ASK query can be issued to verify if the triple pattern is actually empty. If the ask query returns ‘yes’, the rewritings that the joined triple patterns of p1(?y1, ?y2) and p2(?y3, ?y4) are removed. The empty query removal module 154 then generates an optimized query set 162 for querying.

The query management module 156 receives as input the optimized query set 162. The query management module 156 performs a query of base data 164 stored in a base data datastore 166 using the optimized query set 162 (the optimized query set 160, or the query set 158). As can be appreciated, the base data datastore 166 can be implemented as a part of or separate from the optimized query system 128. The query module 156 generates query results 168 from the querying. The query results 168 can be presented to the user via, for example, a user interface in a textual or graphical format.

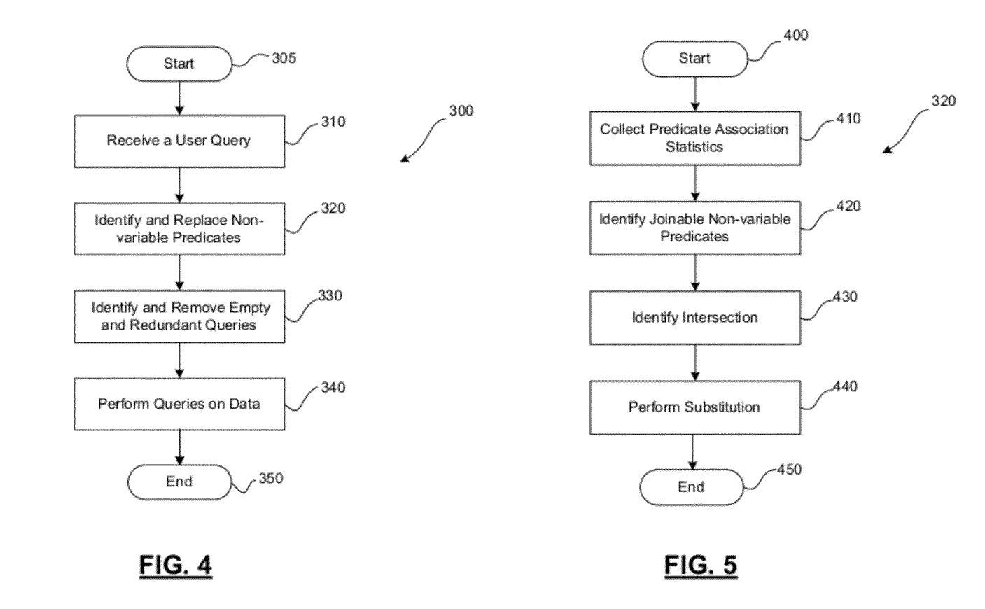

Turning now to FIGS. 4 and 5 and with continued reference to FIG. 3, flowcharts illustrate query methods that can be performed by the optimized query system 128 in accordance with exemplary embodiments. As can be appreciated in light of the disclosure, the order of operation within the methods is not limited to the sequential performance as illustrated in FIGS. 4 and 5, but may be performed in one or more varying orders as applicable and in accordance with the present disclosure. As can be appreciated, one or more steps can be added or deleted from the method without altering the spirit of the method.

With particular reference to FIG. 4, a high level query optimization method 300 is illustrated in accordance with exemplary embodiments. In one example, the method may begin at 305. A semantic database query is received at 310. At least one variable predicate in the semantic database query is identified and replaced with a non-variable predicate at 320 to generate one or more new queries. The one or more new queries are evaluated and any empty or redundant queries are identified and removed at 330. The remaining queries are performed on the datastore to obtain a query result at 340. Thereafter, the method may end at 350.

With particular reference to FIG. 5, a predicate replacement method that may be performed at process 320 is illustrated in accordance with exemplary embodiments. In one example, the method may begin at 400. Predicate-association statistics are collected at 410. For each variable predicate in the query, the set of nearest joinable non-variable predicates in the query are identified at 420. The intersection of joinable predicates in the set is identified at 420. A query for each substitution of the non-variable predicate is generated based on the intersection at 430. Thereafter, the method may end at 440.

As can be appreciated, the terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, element components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated

Further, as will be appreciated by one skilled in the art, aspects of the present invention may be embodied as a system, method, or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The flow diagrams depicted herein are just one example. There may be many variations to this diagram or the steps (or operations) described therein without departing from the spirit of the invention. For instance, the steps may be performed in a differing order or steps may be added, deleted or modified. All of these variations are considered a part of the claimed invention.

While the preferred embodiment to the invention had been described, it will be understood that those skilled in the art, both now and in the future, may make various improvements and enhancements which fall within the scope of the claims which follow. These claims should be construed to maintain the proper protection for the invention first described.

What is claimed is:

1. A method of optimizing a database query, comprising:
performing on a processor:
receiving a database query that includes a plurality of predicates that associate a subject with an object, where one or more of the predicates is a variable predicate;
generating at least one new query by selectively replacing the at least one variable predicate in the database query with a non-variable predicate; and
performing the at least one new database query on a database to obtain a query result.

2. The method of claim 1 wherein the database query is provided in a graph query language.

3. The method of claim 2 wherein the graph query language is at least one of SPARQL, RDQL, and RQL.

4. The method of claim 1 wherein the generating comprises generating a plurality of new queries by selectively replacing the at least one variable predicate in the database query with non-variable predicates, and wherein the performing comprises performing the new queries on the database to obtain query results.

5. The method of claim 4 further comprising providing a union of the query results and returning the union as a result.

6. The method of claim 4 further comprising removing at least one new query based on whether the new query is empty.

7. The method of claim 4 further comprising removing at least one new query based on whether the new query is a redundant new query.

8. The method of claim 4 further comprising re-ordering a sequence of triple patterns in the plurality new queries.

9. The method of claim 1 wherein the selectively replacing further comprises
receiving predicate-association statistics;
identifying a set of nearest joinable non-variable predicates in the database query; and
determining an intersection of joinable predicates in the set.

10. A system for performing a query, comprising:
a computer readable medium that includes:
an optimization module that receives a database query that includes a plurality of predicates that associate a subject with an object, where one or more of the predicates is a variable predicate, and that generates at least one new query by selectively replacing the at least one variable predicate in the database query with a non-variable predicate; and
a query module that performs the at least one new query on a database to obtain a query result.

11. The system of claim 10 wherein the database query is provided in a graph query language.

12. The system of claim 10 wherein the optimization module generates a plurality of new queries by selectively replacing the at least one variable predicate in the database query with non-variable predicates, and wherein the query module performs the new queries on the database to obtain query results.

13. The system of claim 12 wherein the query module provides a union of the query results and returns the union as a result.

14. The system of claim 12 wherein the optimization module removes at least one new query based on whether the new query is empty.

15. The system of claim 12 wherein the optimization module removes at least one new query based on whether the new query is a redundant new query.

16. The system of claim 12 further comprising re-ordering a sequence of triple patterns in the plurality new queries.

17. A computer program product for performing a query issued by a user, the computer program product comprising:
a tangible storage medium readable by a processing circuit and storing instructions for execution by the processing circuit for performing a method comprising:
receiving a database query that includes a plurality of predicates that associate a subject with an object, where one or more of the predicates is a variable predicate;
generating at least one new query by selectively replacing the at least one variable predicate in the database query with a non-variable predicate; and
performing the at least one new query on a database to obtain a query result.

18. The computer program product of claim 17 wherein the database query is provided in a graph query language.

19. The computer program product of claim 17 wherein the generating comprises generating a plurality of new queries by selectively replacing the at least one variable predicate in the database query with non-variable predicates, and wherein the performing comprises performing the new queries on the database to obtain query results.

20. The computer program product of claim 19 further comprising:
removing at least one new query from the plurality of new queries based on whether the new query is empty;
removing at least one new query from the plurality of new queries based on whether the new query is a redundant new query;
re-ordering a sequence of triple patterns in the plurality of new queries; and
providing a union of the query results and returning the union as a result.
